(19) United States
(12) Patent Application Publication
(10) Pub. No.: US 2008/0160350 A1
(43) Pub. Date: Jul. 3, 2008

(54) FUEL CAN STRUCTURE

(76) Inventors: TSANG-MING CHANG, Taipei (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/873,421

(22) Filed: Oct. 17, 2007

(30) Foreign Application Priority Data
Oct. 18, 2006 (TW) 095218360

(51) Int. Cl. H01M 8/02

(52) U.S. Cl. 429/12

(57) ABSTRACT

A fuel can is disclosed, which includes a shell with an inner accommodating space for containing fuels. A fuel outlet portion, an electrical connection interface and a non-return valve are disposed on the shell. A spring-based block component is positioned inside the fuel outlet portion. The spring-based block component includes an extendable pole, a stopper and a spring. The stopper is disposed at a front end of the extendable pole. The extendable pole is sleeved with the spring, and two ends of the spring are positioned against bottoms of the stopper and the fuel outlet portion, respectively. The stopper has an area larger than that of the outlet of the fuel outlet portion, and smaller than that of the horizontal section of the channel in the fuel outlet portion. An elastic force from the spring compels the stopper to block and seal the outlet. The non-return valve is provided to make external air flow into the inner accommodating space of the fuel can unidirectionally, so as to balance a pressure inside the fuel can.

### FIELD OF THE INVENTION

The present invention relates to the structure of a fuel can, and more particularly, to a fuel can adapted to a fuel cell for improving the utility of the fuel cell.

### BACKGROUND OF THE INVENTION

Fuel cells are such devices that convert chemical energy into electric energy by means of the combustion within the cells, and generate power and produce water through the chemical reaction of hydrogen ions with oxygen ions. The difference between the fuel cells and the ordinary cells (e.g. primary batteries and secondary batteries) lies in that the fuel cells do not store energy inside, but ceaselessly generate power from fuels supplied by an external fuel can. Fuel cells are kinds of green energy with high conversion efficiency; hence, how to more effectively enhance the utility of the fuel cells is an important subject. The design of the fuel cans has great influence on the utility of the fuel cells.

A conventional fuel can (also referred to as a fuel cartridge) adapted to a fuel cell is generally designed as a closed container having an outlet disposed on its shell. The fuel can is then connected with an inlet of the fuel cell via a pipe. Though the fuel can of this kind may supply fuels to the fuel cell, it is still inconvenient to use it due to the deployment of pipelines.

In view of the disadvantages of traditional fuel cans for fuel cells, an improved structure of a fuel can is provided in the application to improve the utility of the fuel cans in use.

### SUMMARY OF THE INVENTION

It is one object of the invention to provide a fuel can, which includes a fuel outlet portion disposed thereon and a spring-based block component disposed in the fuel outlet portion. The spring-based block component is used to block and seal the outlet of the fuel outlet portion before the fuel can is connected to a fuel cell.

It is a secondary object of the invention to provide a fuel can including a fuel outlet portion and an electrical connection interface, both of which are disposed on the same side of the fuel can. When the fuel can is mated with a fuel cell, the fuel outlet portion and the electrical connection interface are connected to the fuel cell at the same time.

It is another object of the invention to provide a fuel can with a non-return valve for balancing the pressure inside the fuel can.

In accordance with the aforementioned objects of the invention, a fuel can is disclosed, which includes a shell having an inner accommodating space to contain fuels. A fuel outlet portion, an electrical connection interface and a non-return valve are disposed on the shell. A spring-based block component is positioned inside the fuel outlet portion. The spring-based block component includes an extendable pole, a stopper and a spring. The stopper is disposed at the front end of the extendable pole. The extendable pole is sleeved with the spring, and two ends of the spring are located against bottoms of the stopper and the fuel outlet portion, respectively. The stopper has an area larger than that of the outlet of the fuel outlet portion, and smaller than that of a horizontal section of a channel in the fuel outlet portion. An elastic force from the spring compels the stopper to block and seal the outlet. The non-return valve allows external air flowing into the inner accommodating space of the fuel can unidirectionally, so as to balance the pressure inside the fuel can.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a perspective view of a fuel can according to an embodiment of the invention;

FIG. 2 illustrates a cross-section of the fuel can according to the embodiment of the invention;

FIG. 3 illustrates a cross-section of the fuel can in use according to the embodiment of the invention; and

FIG. 4 shows a fuel can according to the embodiment of the invention, which is connected to a fuel cell.

### DETAILED DESCRIPTION OF THE INVENTION

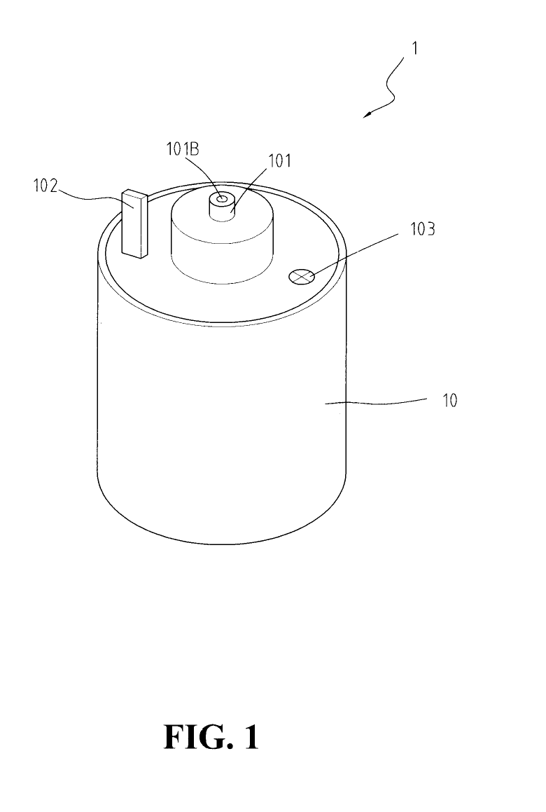

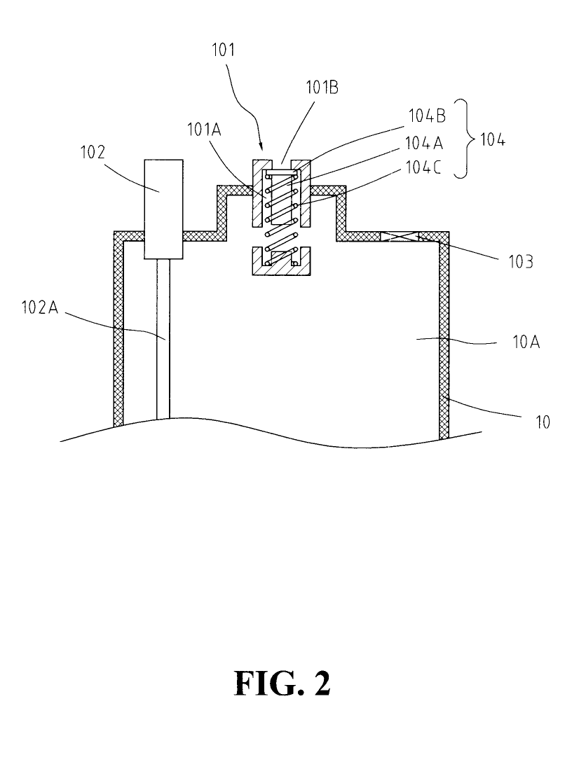

FIG. 1 is a perspective view of a fuel can according to an embodiment of the invention, while FIG. 2 illustrates the cross-section of the fuel can according to the embodiment of the invention. A fuel can 1 includes a shell 10, a fuel outlet portion 101, a non-return valve 103, and a spring-based block component 104. An inner accommodating space 10A is enclosed by the shell 10, so as to form a closed structure. The inner accommodating space 10A is used to contain fuels, such as a direct solution of methanol. The shell 10 may be made from a rigid material like metal, and a surface of the metal material is coated with an anticorrosive layer. Alternatively, the shell 10 may be made of hard plastics. The fuel outlet portion 101, the electrical connection interface 102 and the non-return valve 103 are disposed on the shell 10.

The spring-based block component 104 is positioned inside the fuel outlet portion 101, and includes an extendable pole 104A, a stopper 104B and a spring 104C. The stopper 104B is disposed at a front end of the extendable pole 104A. The extendable pole 104A is sleeved with the spring 104C. Two ends of the spring 104C are positioned against bottoms of the stopper 104B and the fuel outlet portion 101, respectively.

The stopper 104B has an area larger than that of the outlet 101B of the fuel outlet portion 101, and smaller than that of a horizontal section of a channel 101A in the fuel outlet portion 101. An elastic force from the spring 104C compels the stopper 104B to lean against and block the outlet 101B of the fuel outlet portion 101, and then seal the outlet 101B. The outlet 101B may be properly composed of flexible materials.

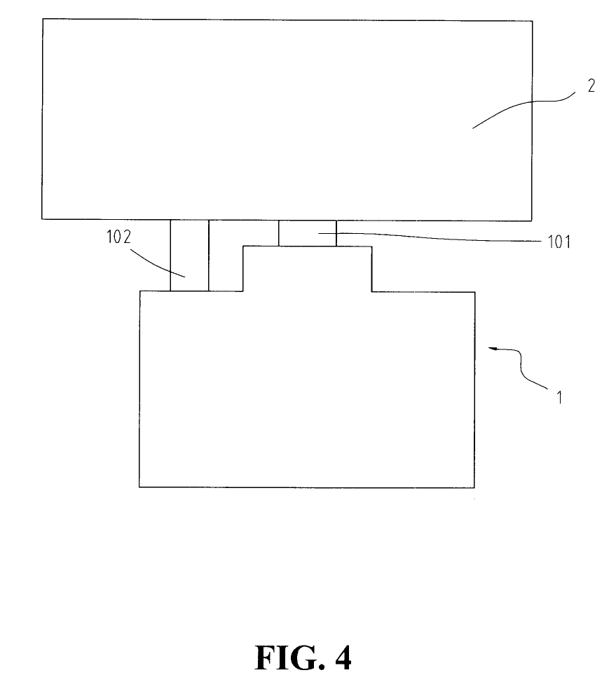

The electrical connection interface 102 is arranged on the same side as the fuel outlet portion 101. The electrical connection interface 102 may be electrical connectors. Alternatively, at least one electrical contact (not shown) is disposed on the surface of the electrical connection interface 102 where the electrical connection interface 102 is coupled with a fuel cell 2 (FIG. 4).

The electrical connection interface 102 is electrically connected to a liquid leveler 102A. The liquid leveler 102A may directly extend into the shell 10 to contact the fuels therein. Alternatively, the liquid leveler 102A may be mounted on an inner wall of the shell 10 and reach for the fuels.

The non-return valve 103 is provided to make external air flow into the inner accommodating space 10A of the fuel can 1 unidirectionally, so as to balance the pressure inside the fuel can 1. Also, the non-return valve 103 is provided to prevent the fuels within the inner accommodating space 10A from exiting through the non-return valve 103.

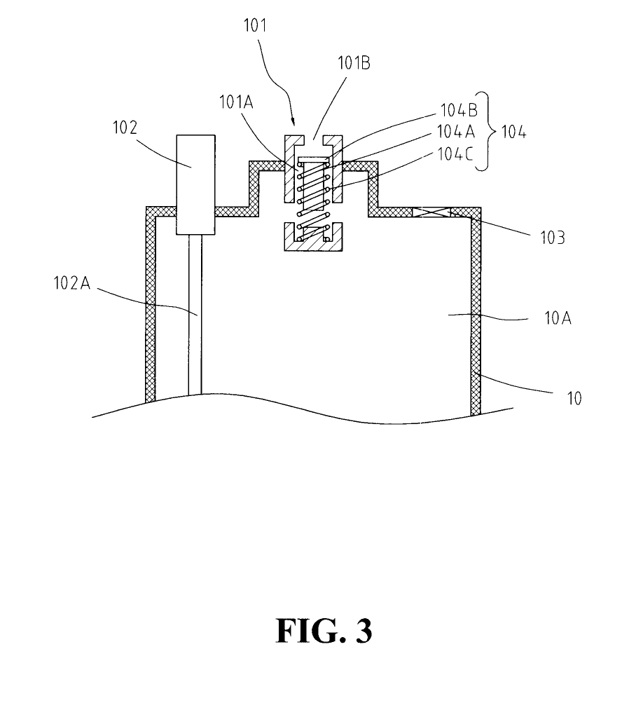

FIG. 3 illustrates the cross-section of the fuel can in use according to the embodiment of the invention. FIG. 4 shows a fuel can in accordance with the embodiment of the invention, which is connected to a fuel cell. When the fuel can 1 is connected to the fuel cell 2, a bulged structure of the fuel cell 2, such as a pin, a stud, and so on, is inserted into the outlet 101B of the fuel outlet portion 101, and thereby pushes the stopper 104B out of the outlet 101B. As a result, the fuels in the inner accommodating space 10A may pass through the channel 101A and the outlet 101B, and flow into the fuel cell 2.

In FIG. 4, while the fuel outlet portion 101 of the fuel can 1 is plugged into the fuel cell 2 in a connecting direction, the electrical connection interface 102 of the fuel can 1 is connected to the fuel cell 2 as well. Correspondingly, the connection of the fuel outlet portion 101 of the fuel can 1 and the connection of the electrical connection interface 102 are completed at the same time.

Due to the elastic force induced by the spring-based block component 104 disposed inside the fuel outlet portion 101 of the fuel can 1 and a movement of the stopper 104B pushed by the bulged structure of the fuel cell 2, the utility of the fuel can 1 described herein is improved. This is the first feature and efficacy of the invention.

Because the electrical connection interface 102 is arranged on the same side of the fuel can 1 as the fuel outlet portion 101, and the liquid leveler 102A is electrically connected to the inner of the shell 10, the electrical connection interface 102 and the fuel outlet portion 101 are coupled with the fuel cell 2 simultaneously. It is thus easy to identify a content of fuels within the fuel can 1 after the fuel can 1 is connected with the fuel cell 2. This is the second feature and efficacy of the invention.

As the fuel can 1 supplies fuels, the non-return valve 103 of the fuel can 1 allows external air flowing into the fuel can 1 ceaselessly to balance the pressure inside the fuel can 1, such that the fuel can 1 supplies fuels more smoothly. This is the third feature and efficacy of the invention.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel can, comprising:
a shell in a form of a closed structure having an inner accommodating space, wherein the shell is made from a rigid material, and the inner accommodating space contains a fuel;
a fuel outlet portion disposed on the shell;
a spring-based block component positioned inside the fuel outlet portion, comprising an extendable pole, a stopper and a spring, wherein the stopper is disposed at a front end of the extendable pole; the extendable pole is sleeved with the spring; and two ends of the spring are separately positioned against bottoms of the stopper and the fuel outlet portion, wherein the stopper has an area larger than an area of an outlet of the fuel outlet portion and smaller than an area of a horizontal section of a channel in the fuel outlet portion, while an elastic force induced by the spring compels the stopper to block the outlet of the fuel outlet portion and seal the outlet;
an electrical connection interface disposed on the shell and arranged on a same side as the fuel outlet portion, such that the electrical connection interface is connected to a fuel cell while the fuel outlet portion is connected with the fuel cell; and
a non-return valve disposed on the shell to make external air flow into the inner accommodating space unidirectionally, so as to balance a pressure inside the fuel can.

2. The fuel can of claim 1, wherein the rigid material comprises a metal coated with an anticorrosive layer.

3. The fuel can of claim 1, wherein the rigid material comprises hard plastics.

4. The fuel can of claim 1, further comprising a liquid leveler electrically connected to the electrical connection interface for contacting the fuel within the inner accommodating space of the shell.

5. The fuel can of claim 1, wherein the electrical connection interface is an electrical connector.

6. The fuel can of claim 1, wherein the electrical connection interface comprises at least one electrical contact.

7. The fuel can of claim 1, wherein the fuel is a direct solution of methanol.

8. The fuel can of claim 1, wherein the non-return valve comprises an inside structure to avoid backflow.
